(19) United States
(12) Patent Application Publication
(10) Pub. No.: US 2006/0151631 A1
(43) Pub. Date: Jul. 13, 2006

(54) Dredging, scouring, excavation and cleaning

(76) Inventor: John H. Redding, Lamberhurst (GB)

Correspondence Address: CONNOLLY BOVE LODGE & HUTZ LLP, SUITE 800, 1990 M STREET NW, WASHINGTON, DC, 20036-3425, US

(21) Appl. No.: 10/535,459

(22) PCT Filed: Nov. 19, 2003
(86) PCT No.: PCT/GB03/05030

§ 371 Date: Nov. 7, 2005

(30) Foreign Application Priority Data
Nov. 19, 2002 (GB) 0227016.3

(51) Int. Cl. B05B 1/34

(52) U.S. Cl. 239/383; 239/469

(57) ABSTRACT

The present invention relates to underwater excavation of sediments and soils and simultaneous controlled movement of the excavated material. In particular, we will describe apparatus for bulk and selective excavation of sand, silt, clay and like materials from sea, river, canal and lake beds, and near-bed movement of the excavated material in a controlled fashion. Controlled, in this sense, refers to the direction and distance of movement and height of transport above the bed. The apparatus, at a smaller scale, may also be used for the removal of bio-fouling from vessels and marine structures; and at a smaller scale still, for hand-held underwater cleaning operations. We describe a fluid jet generating apparatus comprising swirling jet flow creating means. The apparatus suitably includes a duct having a fluid inlet (2) and a fluid outlet (3). In one embodiment, the apparatus comprises a propeller (5) mounted for co-axial rotation within the duct. In an alternative embodiment, the duct incorporates a static swirl generator (45) adapted to impart swirl to a fluid transmitted to the duct under pressure. The duct may further comprise a flared nozzle (47).

The present invention relates to underwater excavation of sediments and soils and simultaneous controlled movement of the excavated material. In particular, we will describe apparatus for bulk and selective excavation of sand, silt, clay and like materials from sea, river, canal and lake beds, and near-bed movement of the excavated material in a controlled fashion. Controlled, in this sense, refers to the direction and distance of movement and height of transport above the bed. The apparatus, at a smaller scale, may also be used for the removal of bio-fouling from vessels and marine structures; and at a smaller scale still, for hand-held underwater cleaning operations.

A cutter-suction dredger is the most widely used apparatus for bulk removal of underwater sediments and soils. With this type of dredging apparatus, bed material is mechanically dis-aggregated by a rotating cutter, mounted in the suction head; while simultaneously, a mixture of soil particles and water is drawn up through the suction pipe, as the suction head is trailed across the bed. The soil/water suspension is typically discharged into a hopper on the vessel, and once the hopper is full, the vessel steams to a suitable disposal site and the contents of the hopper are discharged. The disposal site may be at sea or on land, but is often many kilometres from the excavation site.

The present apparatus achieves dis-aggregation of the bed material by non-mechanical (hydro-dynamic) means, and the excavated material is not brought onto the vessel, but rather is made to flow across the bed, away from the excavation site. Depending on the nature of the bed material and the requirements of the project, excavated material can be re-deposited locally (adjacent to the excavation site) or can be made to flow long distances (up to hundreds of metres with the full-size apparatus) as a highly turbid near-bed suspension (turbidity current). Since turbidity currents tend to flow downhill, material excavated from shoal areas invariably ends up being deposited in deeper water. Such gravity-driven transport has particular advantages for navigation channel maintenance work, which is one of the primary uses of this equipment.

In its broadest sense, the present invention provides a fluid jet apparatus designed to create a swirling jet flow.

In a first embodiment, the apparatus comprises a duct having a fluid inlet and a fluid outlet, and a propeller mounted for co-axial rotation within the duct, wherein the propeller is suitably adapted to produce a variety of swirling jet flows.

In a second embodiment, the apparatus comprises a duct having a fluid inlet and a fluid outlet, the duct incorporating a static swirl generator designed to impart swirl to a fluid transmitted to the duct under pressure.

Advantageously, a flared nozzle may also be placed over or incorporated into the fluid outlet of the duct, to further modify (expand) the jet for the purpose of seabed excavation.

The fluid jet apparatus is capable of being mounted in a variety of ways such that the jet can be maintained at a controlled angle to, and height above, the bed (or surface to be jetted).

Typically, the fluid is water.

Preferably, the apparatus generates a jet having a pre-determined Jet Swirl Number of from about S=0.3 to about S=4.

It will be appreciated, by those skilled in the art, that the swirl content (as defined by the Swirl Number of the flow, see Appendix A) and fluid-dynamic character of the jet are determined, in the first instance:

In the first embodiment, by the propeller; and in particular, by the number, pitch and shape of the blades; the speed of rotation of the propeller and by the flow of fluid through the duct, and

In the second embodiment, by the way in which the swirling jet is generated and emitted from the nozzle; and the pressure driving the flow.

Additionally, it will be appreciated by those skilled in the art, that the processes involved with excavation and controlled movement of seabed material by means of an impinging swirling jet, depend not only on the character of the jet itself. They also depend on how the jet interacts with the bed, the geotechnical nature of the bed material, how the excavated material is subsequently transported and how the whole process is controlled and regulated.

The above and other aspects of the present invention will now be described in further detail, by way of example only, with reference to the accompanying drawings, in which:

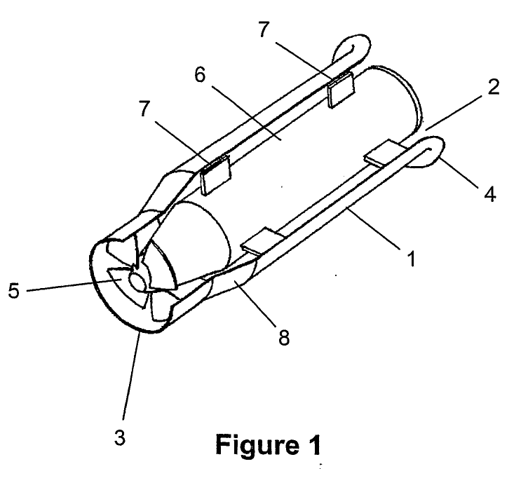

FIG. 1 shows, schematically, the principle features of a first embodiment of a fluid jet apparatus in accordance with the present invention (note this is a cut-away drawing with part of the duct removed);

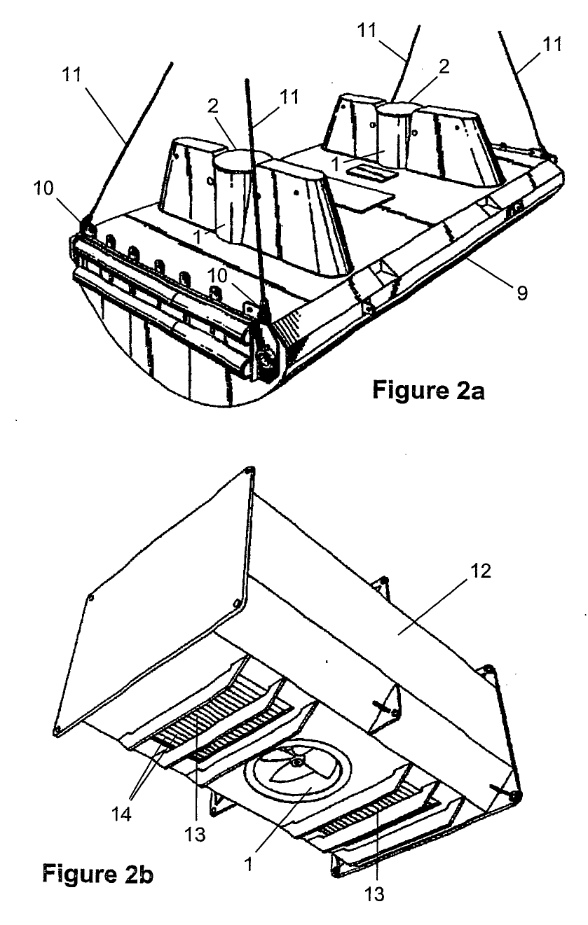

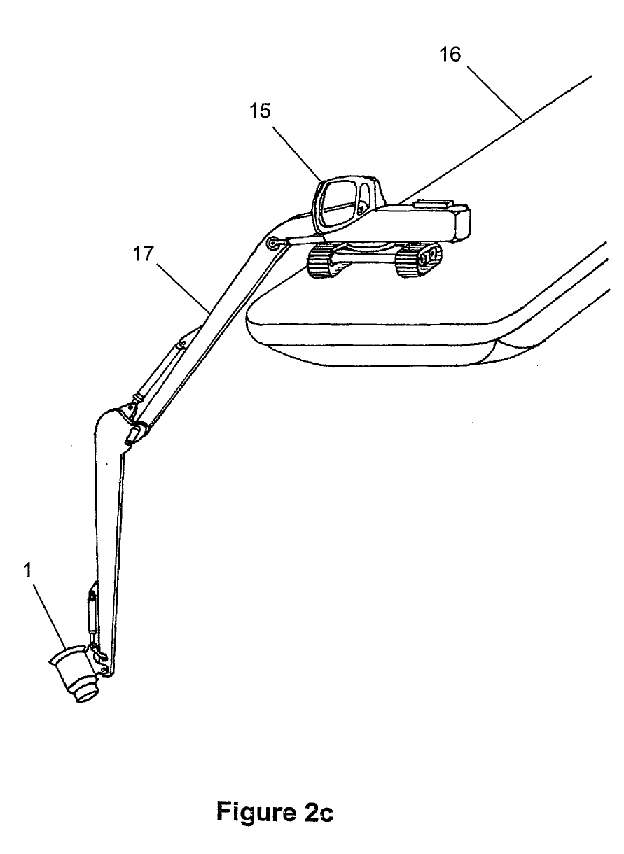

FIGS. 2a, b and c illustrates various ways in which the apparatus of FIG. 1 may be deployed from a floating vessel, including—a suspended Wing-mounted apparatus (FIG. 2a), a suspended tank-mounted apparatus (FIG. 2b), and a mechanical excavator vehicle-mounted apparatus (FIG. 2c);

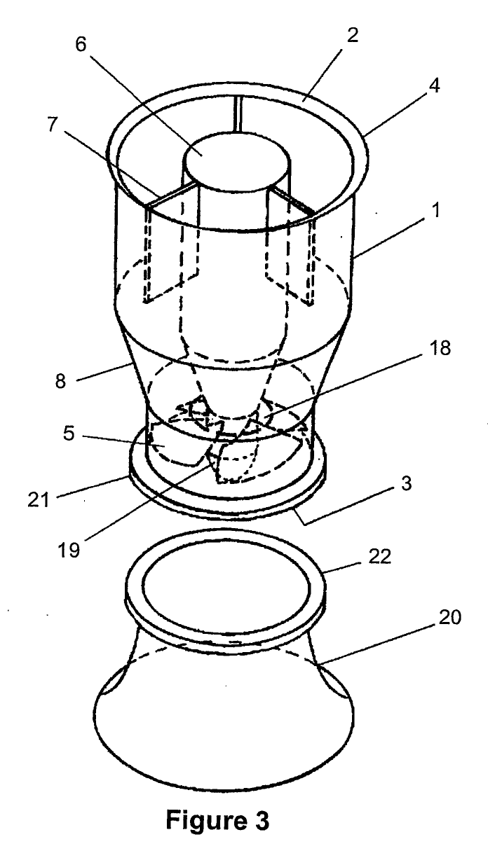

FIG. 3 shows two arrangements for significantly modifying the jet from the apparatus of FIG. 1 by inclusion of a disc in front of the propeller and by the fitting of a flared nozzle over the duct outlet;

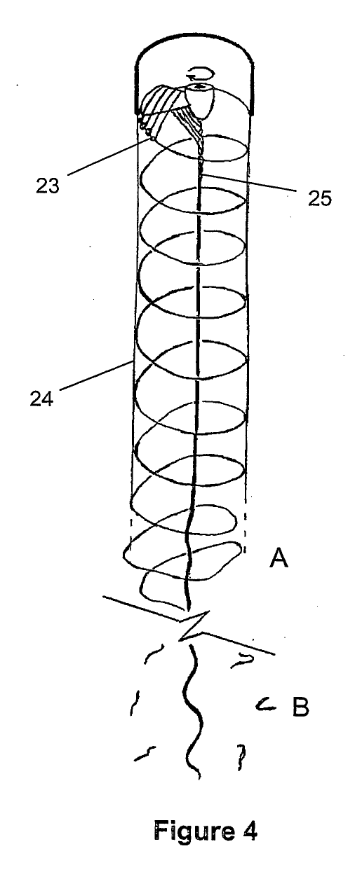

FIG. 4 is a schematic illustration of the principal flow components of the basic free-stream jet formed by the apparatus of FIG. 1;

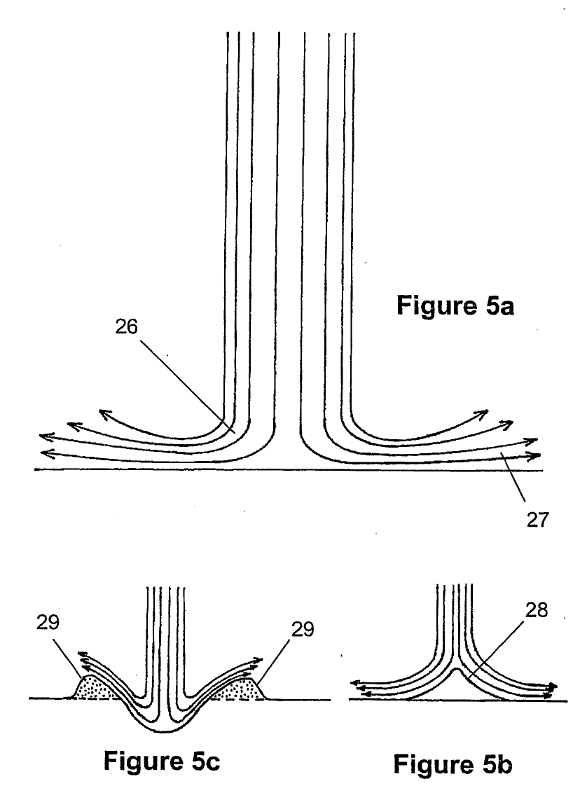

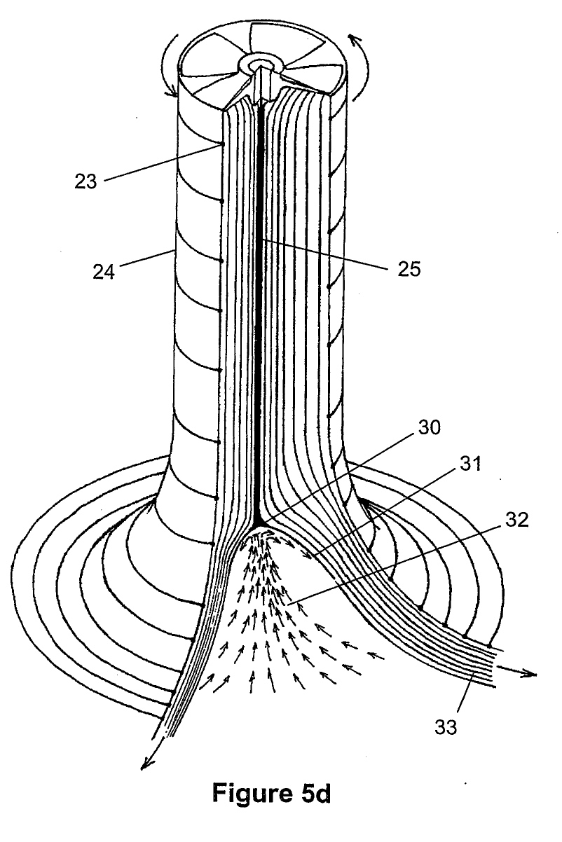

FIGS. 5a, b, c and d show diagrammatic representations of the impingement processes associated with near-bed jetting with the basic jet of the apparatus of FIG. 1. FIGS. 5a, b and c shows jetting onto a rough bed (i.e. sand); FIG. 5d shows jetting onto a smooth bed (i.e. clay);

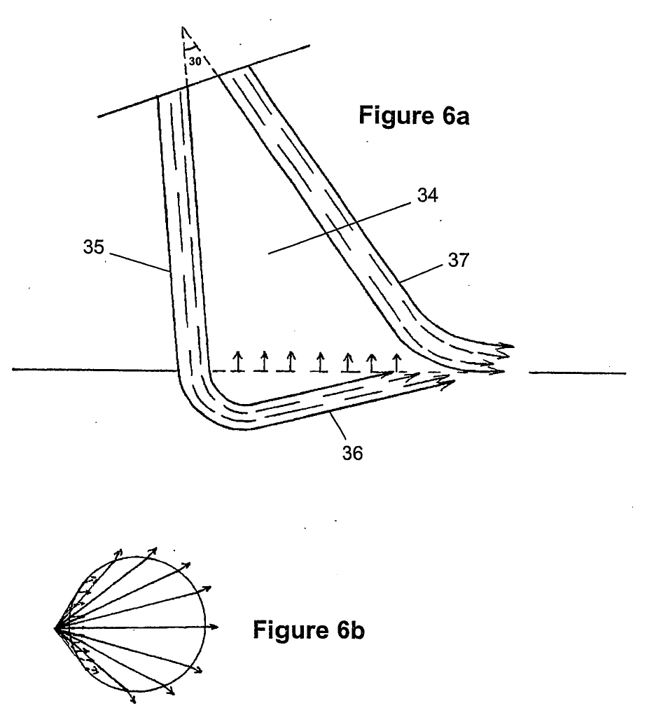

FIGS. 6a and b show diagrammatic representations of the jet flow characteristics and impingement processes associated with the fore-propeller disc fitted in the apparatus of FIG. 3;

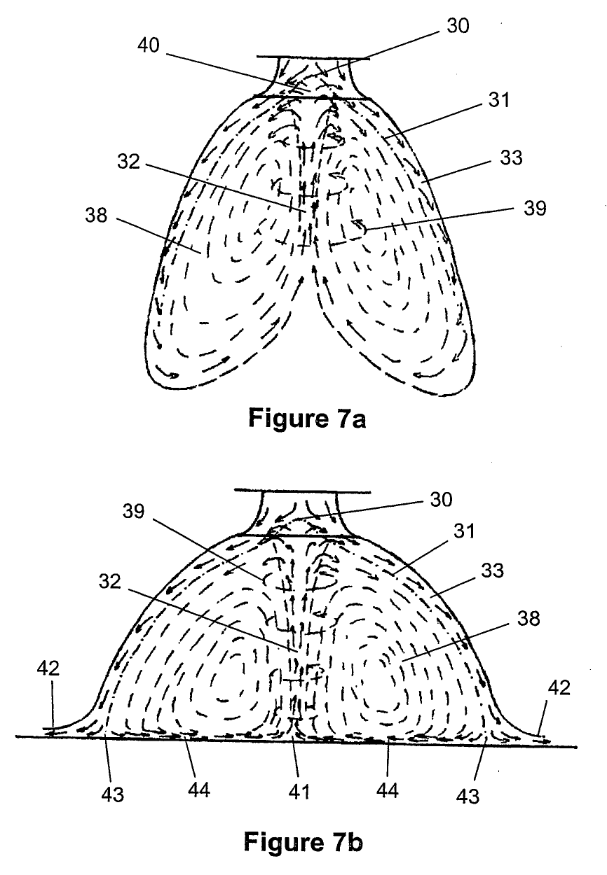

FIGS. 7a and b show diagrammatic representations of the jet flow characteristics and impingement processes associated with the apparatus when either the fore-propeller disc or the conical after-body is fitted, together with the flared nozzle. FIG. 7a shows the free jet; FIG. 7b shows the impinging jet (Note these drawings apply equally to the operation of the second embodiment, when a flared nozzle is incorporated);

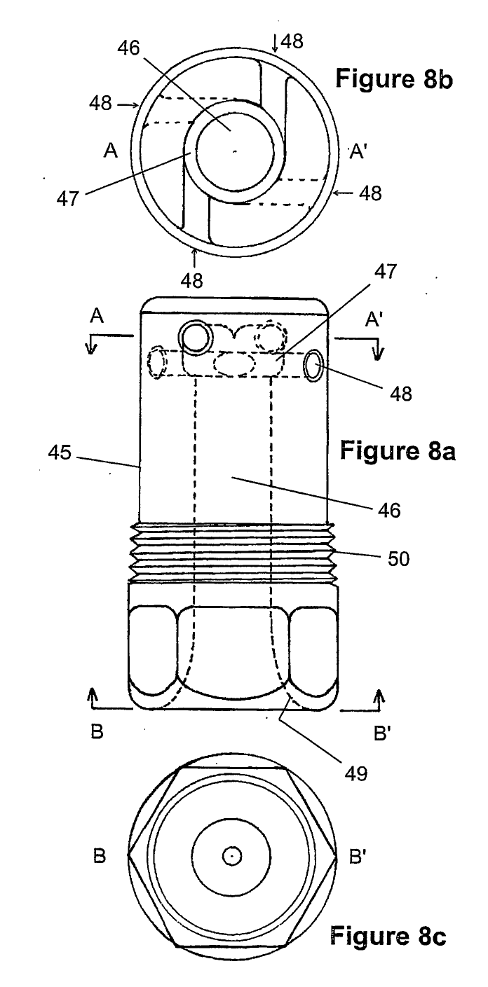

FIGS. 8a, b and c show, schematically, the principle features of a second embodiment of a fluid jet apparatus in accordance with the present invention;

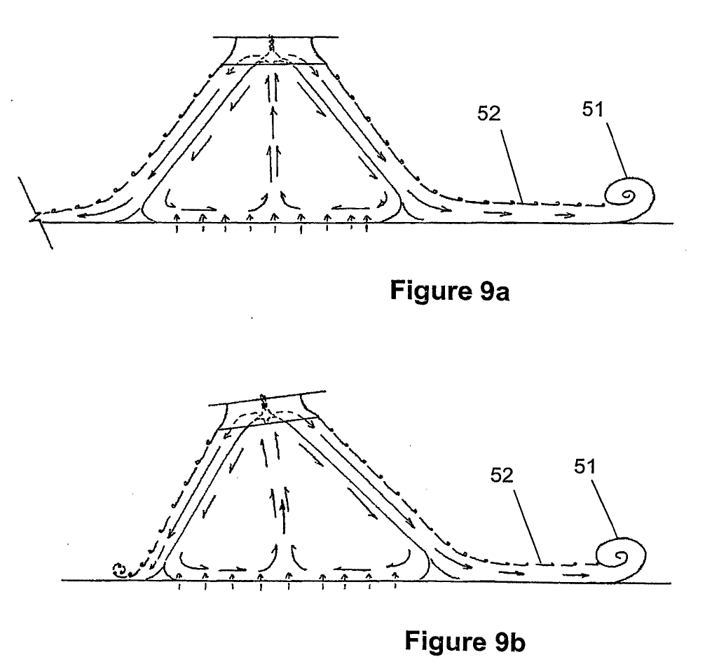

FIGS. 9a and b show diagrammatic representations of the formation of a turbidity current flow by the apparatus of the first and second embodiments. FIG. 9a shows orthogonal jetting; FIG. 9b shows inclined jetting;

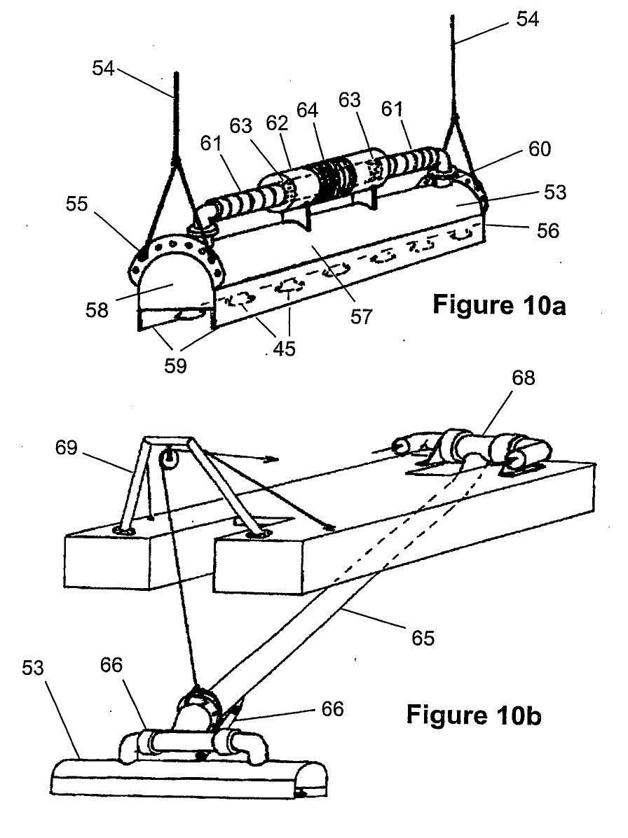

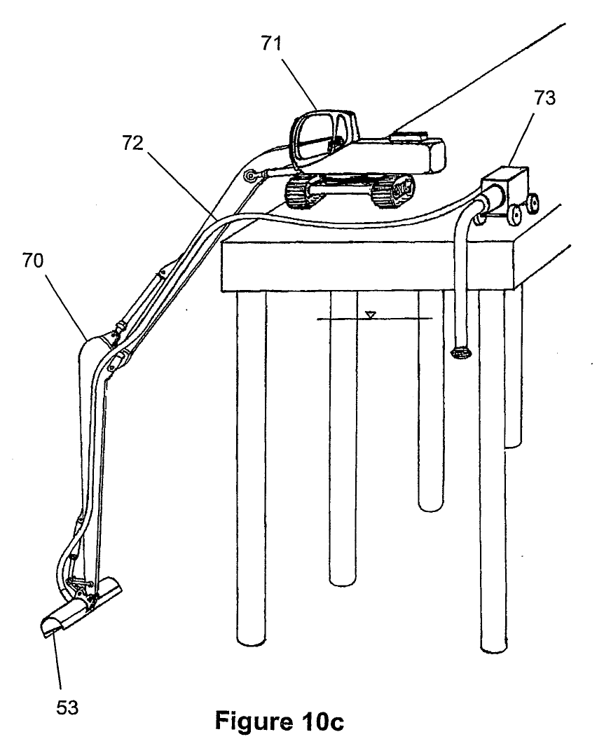

FIGS. 10a, b and c illustrate various ways in which the apparatus of FIG. 8 may be deployed in a multi-jet arrangement from a floating vessel, including—a suspended manifold-mounted apparatus (FIG. 10a), a T-shaped articulating manifold-mounted apparatus (FIG. 10b), and a mechanical excavator vehicle manifold-mounted apparatus (FIG. 10c);

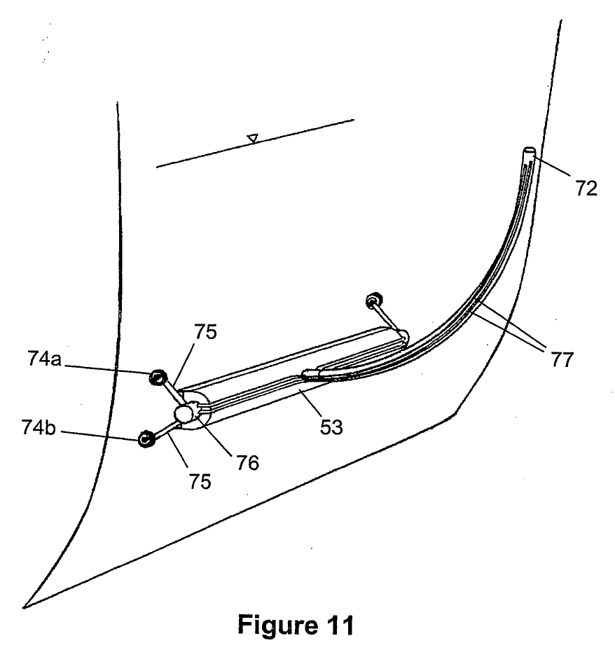

FIG. 11 shows a way in which the apparatus of FIG. 8 might be used in a multi-jet arrangement for vessel cleaning; and

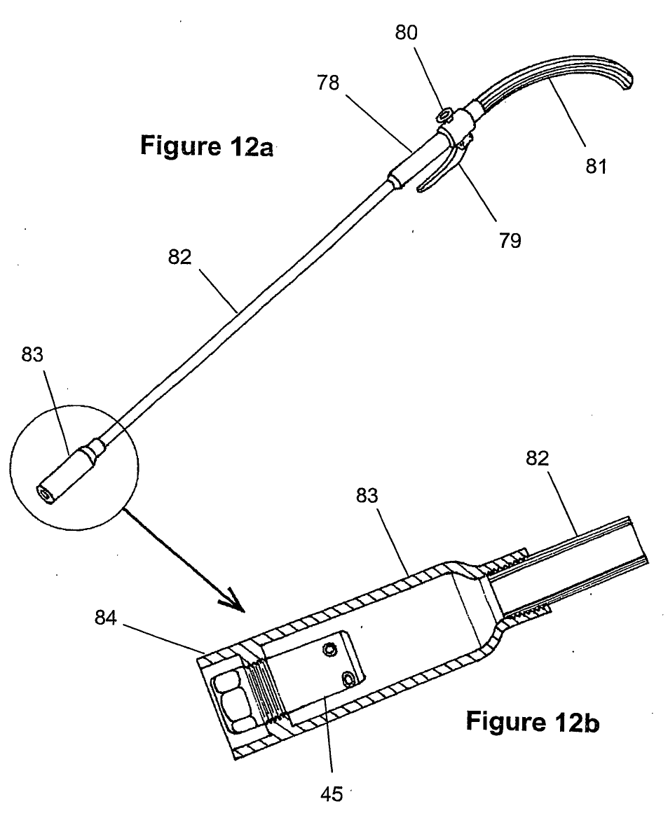

FIG. 12 shows a single jet hand-held deployment arrangement of the apparatus of FIG. 8 that might be used for small-scale cleaning operations.

Referring initially to FIG. 1, there is illustrated (in cut-away form) the first embodiment of the fluid jet-producing apparatus of the present invention. The apparatus comprises a duct 1 having an inlet 2 and an outlet nozzle 3. The inlet 2 is in the form of a bell-mouth 4 to facilitate uniform ingress of fluid into the duct. Mounted within the outlet nozzle of the duct is a propeller 5. Propeller 5 is mounted for rotation about an axis coaxial with the duct itself. Propeller 5 is caused to rotate by any suitable means. For example, rotation may be imparted to the propeller by means of an electric, hydraulic or pneumatic motor 6. In the arrangement shown, an electric motor is used, supported and spaced from the inner wall of the duct 1 by means of fins 7.

It will be observed from FIG. 1 that outlet nozzle 3 is of smaller diameter than inlet 2 and that a constriction 8 provides a transition zone between the two areas. This arrangement ensures a uniform flow velocity through the annulus formed between the body of the motor 6 and the duct 1.

The propeller is multi-bladed and although FIG. 1 shows a 4-bladed propeller, the actual number of blades may be any number from 3 or more. The propeller has a large blade area ratio, which is defined as the sum of the area of the blades divided by the area of the propeller disc (or nozzle area). The blade outline is symmetrical (i.e. non-skewed) and the angle of pitch of each blade varies in such a way that the pitch/diameter ratio increases from approximately 1 at the blade tip to 1.2 at the hub. This, together with the fact that the blades are of uniform depth when viewed side-on, ensures a high swirl content to the flow emitted from the apparatus. The type of propeller shown in FIG. 1 is known as a Kaplan propeller, which typically has symmetrical aerofoil blade section geometry. This enables the propeller to be operated equally well when rotating in either direction.

The propeller is close fitting inside the outlet nozzle, which means that all the water passing through the duct is forced to pass through the propeller disc. In use, the propeller is made to rotate at high speed, typically in the region of 15 revolutions per second (900 RPM).

For the type of seabed excavation work normally carried out with this first embodiment invention, the outlet nozzle duct would have a diameter of about 0.5 to 0.75 m and the speed of rotation of the outer tips of the propeller blades would be in the region of 30 to 35 m/sec. The duct would be pointed towards the bed, either vertically downwards or at an angle, and maintained at a controlled height above the bed.

The apparatus of the first embodiment invention may be deployed in a number of ways, as illustrated in FIGS. 2a, b and c.

The ‘Wing Dredger’ means of deployment (shown in FIG. 2a) comprises a steel body 9, which may be in the form of an inverted wing profile. The inverted wing profile provides stability in fast-moving currents. Attachment points 10 on the top edge of the body 9 enable the body to be suspended from four wires 11. The wires provide the means for suspension of the body from a vessel-mounted A-frame or crane (not shown). By suitable paired adjustment of the length of the wires 11, the angle of forward/backward tilt (pitch) and sideways tilt (roll) of the body can be controlled. In the ‘Wing Dredger’ the ducts 1, which generate the jets, are in pairs and the duct intakes 2 are located outside and above the top of the body 9. In this paired duct arrangement, the propellers are contra-rotating to ensure torsional stability of the suspended body in the water.

The overall length of the ducts, as shown, is a function of the length of electric motors used to drive the propellers (see FIG. 1). This is because a continuous flow of water is required across the length of the motors for cooling purposes.

In the arrangement shown in FIG. 2b, the body 12 is in the form of a rectangular steel box or tank, which can, similarly, be suspended by wires from a vessel-mounted A-frame or crane. The body houses a single duct 1, mounted wholly within the body 12, such that the duct inlet is also enclosed by the body. Ingress of water into the body, and thence into the duct, takes place through openings 13 on the underside of the body. Hinged louvre plates 14 positioned inside and across the openings 13 protect the body (and thereby the duct) from ingress of debris and also enable the flow of water into the body (and thereby the duct) to be adjusted.

It will be appreciated that in order to produce the tank arrangement shown in FIG. 2b, duct 1 has to be significantly shorter than that shown in FIG. 1 and FIG. 2a. Accordingly, the motor used in the FIG. 2b deployment means is of the hydraulic type, the latter motors being more compact than the equivalent power electric motors. A sketch of the duct/motor/propeller arrangement used in the FIG. 2b deployment means is shown in FIG. 3. Notwithstanding the reduction in length of motor and duct, in all other respects (i.e. shape of duct and design of the propeller) the FIG. 2a and FIG. 2b deployment means ducts are identical.

A feature of the FIG. 2b deployment means is that it can be used either as a single-jet unit or in a multiple-jet arrangement. In the latter arrangement, several single-jet units can be coupled together in different configurations.

In the deployment means shown in FIG. 2c, duct 1 (which has the same duct/motor/propeller design as in FIG. 2b deployment means, and which is shown in FIG. 3) takes the form of an attachment to the backhoe arm of a long-reach excavator 15. Although only a single duct attachment is shown in FIG. 2c, it will be appreciated that more than one duct attachment may be used, depending on the size of the excavator. For the purposes of over-water operation, the long-reach tracked excavator shown, is mounted on a spud barge 16. The long-reach excavator uses its hydraulic arm 17 to manipulate duct 1, controlling the latter's position, height above the bed and angle of tilt. The excavator can also use the duct as a means for propelling and manoeuvring the spud barge, rather like an azimuth thruster. However, this is not the primary function of the duct.

The arrangement shown in FIG. 2c is a particularly useful one for shallow-water excavation and for bio-foul removal operations, as the track-mounted excavator vehicle can be either land-based (i.e. operating from a dock or quay) or, as shown, supported over-water on a barge.

The fluid flow output from the said first embodiment jetting apparatus comprises a swirling jet of water, embedded within which is an organised arrangement of vortical flow structures (vortices), which represent the shed boundary layer from the propeller. The jet is circular in outline, which is a direct consequence of the form of the duct and the outlet nozzle of the equipment. The amount of swirl contained in the jet, is primarily, a function of the pitch of the propeller blades and their angular velocity. Since swirl and axial flow are generated together by the propeller, Swirl Number provides a convenient means of comparing the strength of these two flow components. Swirl Number (S) (see Appendix A for a full definition) is the ratio of the axial fluxes of swirl (tangential) and linear (axial) momentum, divided by a characteristic radius; in this case the radius of the outlet duct.

Swirl is important to the internal stability and behaviour of the jet, as discussed later. For the present, it is sufficient to note that the first embodiment apparatus produces a jet with a range of Swirl Numbers from S=0.3 to S=4.0. For operational purposes the Jet Swirl Number can be varied in a number of ways:

1. By selecting propellers with blades of different pitch and pitch profile (this provides a range of Jet Swirl Numbers from about 0.3 to about 0.6).

2. By fitting a disc (18 in FIG. 3) co-axially in front of the propeller, which has the effect of cutting out the axial flow through the central part of the propeller leaving only swirl generated. Depending on the diameter of the disc relative to the propeller, the Swirl Number of the flow can thus be raised from S=0.6 to S=1.3. Alternatively to 2., by replacing the normal rounded nose cone 19 with a conical nose cone (not shown). This has the effect of inducing a component of radial velocity at the expense of axial velocity and thus increasing the Jet Swirl Number.

3. By bringing the apparatus closer to the bed. Reaction from the bed has the effect of reducing the axial velocity of the jet and thus increasing the Swirl Number. This effect is most noticeable in clay.

4. Additionally, in the case of the FIG. 2b deployment means, the amount of inflow to the duct can be reduced by partially closing the louvre plates. This also has the effect of increasing the Swirl Number of the jet.

5. By fitting a flared nozzle (20 in FIG. 3) co-axially over the outlet by means of mating flanges 21 and 22. The flared nozzle has the effect of expanding the flow, thus reducing the axial velocity and increasing the Swirl Number of the jet. By means of the flared nozzle and either the fore-propeller disc or the conical nose cone, the Swirl Number of the jet can be raised to a maximum of S=4.

In order to promote a fuller understanding of the present first embodiment invention, the swirling character of the jet and the effect of changing the Jet Swirl Number will now be described in further detail. For the purposes of this discussion, the jet is assumed to be emerging into still water (i.e. no relative movement between the apparatus and the ambient fluid).

The general features of the free-stream jet are as shown diagrammatically in FIG. 4. Note that for clarity, only one propeller blade and its corresponding tip vortex are shown. Whilst FIG. 4 relates more particularly to non-ducted propellers, the general features apply equally to the ducted propellers of the present first embodiment invention. Further details and the justification for the flow structures present in propeller jets (wakes) may be found in: Stella et al (Stella A., Guj G., Di Felice F., and Elefante M.—Experimental Investigation of Propeller Wake Evolution by Means of LDV and Flow Visualisation, Journal of Ship Research, Vol 44, No 3 (2000), 155-169) and in: Di Florio et al (Di Florio D., Di Felice F., Romanon G. P., and Elefante M.—Propeller Wake Structure at Different Advance Coefficients by means of PIV, Proceedings of PSFVIP—3—Mar. 18-21, 2001, Maui, Hi., USA).

FIG. 4 shows also how the character of the jet changes with distance from the nozzle in the case of a non-impinging jet (i.e. with the apparatus operating at a significant height above the bed). It is appropriate to consider this situation first, before looking at the situation of the jet impinging on the bed.

With a Jet Swirl Number of between 0.3 and 0.6 the jet remains essentially straight-sided for at least 4-5 propeller diameters downstream. This columnar jet structure is partly a function of the swirling nature of the jet, but more particularly because the Reynolds boundary stresses (the shear stresses at the boundary between the jet and the ambient fluid) are low. There is thus little interaction between the jet and the ambient fluid. Tip vortices 23, diffused from the outer edge of each propeller blade and convected downstream with the jet flow, collectively define the boundary of the jet, or stream tube 24. Having a long, straight-side, jet, which retains its axial velocity, is useful for “stand-off” jetting of structures such as pipelines, which can be susceptible to mechanical damage. By contrast, in a normal (non-swirling) turbulent round jet, interaction between the jet and the ambient fluid results in entrainment (assimilation) of ambient fluid and a progressive spreading of the jet, with attendant reduction in axial velocity.

FIG. 4 shows that at about 4-5 propeller diameters downstream (marked A in FIG. 4), the stream tube begins to lose its circular form. This instability is associated with a progressive downstream reduction in axial velocity and a corresponding increase in Swirl Number of the jet. The jet is becoming more precessional in character, with an increase in Reynolds boundary stress causing interaction with the ambient fluid. The hub vortex 25 (created by the inward component of propeller boundary layer flow), although persisting as a coherent structure, also exhibits a slight spiral (precessing) flexure.

By ten propeller diameters (marked B in FIG. 4) the tip vortices 23 and the stream tube envelope have effectively ceased to exist. The hub vortex 25 exhibits a considerable amount of spiral flexure, indicating strong precessional motion within the jet. The jet is now beginning to spread out.

The sequence of changes that eventually leads to full breakdown of the jet, in the far wake, is a result of the progressive increase in Swirl Number within the jet, as the axial velocity of the jet reduces. This sequence can be foreshortened by increasing the Swirl Number of the primary jet by any of the means outlined earlier.

In the case of the basic propeller jet impinging upon the seabed, not only the character of the jet, but the distance from the bed, the angle of incidence of the jet and the nature of the bed material are all critical to the resulting behaviour of the impinging jet. Under typical operating conditions for near-bed jetting, the first embodiment fluid jet apparatus would not be operated at less than one propeller diameter from the bed. Two to three propeller diameters would be a typical minimum distance for jetting.

FIG. 5a illustrates the typical impingement behaviour of the basic jet (with no disc or conical nose cone and no flared nozzle fitted), in the case of near-bed jetting onto a rough or frictional surface, such as sand or gravel, with the jet orientated orthogonal to the bed. The same type of impingement behaviour occurs over a wide range of nozzle distances from the bed. For the sake of illustration, the FIG. 5a bed is assumed to be non-erosional.

Because the swirl component of the jet is rapidly dissipated in the presence of strong bed friction, the jet behaves rather like a normal turbulent round jet, with the axial component of flow exerting thrust on the bed and being deflected radially in the impingement zone 26 to form a wall jet 27. The swirling jet differs from a normal turbulent round jet (as shown in FIG. 5b), however, in that it maintains its width much closer to the bed (does not splay out due to the formation of a stagnation pressure cone 28). Deflection of axial flow thus occurs very close to the bed, and so the effect is more like a pipe emitting flow when brought very close to the bed. The deflected axial flow is pressed against the bed by the force of the impinging jet and so it exerts much higher erosive power than an equivalent non-swirling jet. The radially spreading high-velocity wall jet flow 27, on the other hand, slows rapidly with distance away from the impingement site. In so doing it experiences an adverse pressure gradient, which causes it to lift off the bed, further bed erosion and transport of material is thus quickly curtailed. Scouring with this type of jet, therefore, tends to be very localised, with the excavated material being deposited 29 very close to the impingement site (see lower inset, FIG. 5c).

A further factor leading to concentration of erosion and localised deposition (i.e. scouring) of material, is pressure leakage from the jet into the bed. This is reported by Kobus et al (Kobus H, Leister P. and Westerich B.—Flow Field and Scouring Effects of Steady and Pulsating Jets Impinging on a Movable Bed, Jour. Hydraulic Research, Vol 17, No 3 (1979) 175-192), in experiments on erosion in sand by normal turbulent round jets.

Experience with the full-size apparatus operating in sand indicates that, with the jet moving forward, a narrow trench is formed with the excavated material being deposited in the form of levees on either side of the trench. The maximum distance that the excavated sand is moved is approximately 10-15 m, which is consistent with a bed-load and/or low concentration suspension mode of transport by the deflected jet. By tilting the jet, excavated material can be displaced preferentially in the direction that the jet is pointing. However, the distance of movement of the material is still, typically, less than 20 m.

In the case of a bed formed of clay or similar low-friction material (e.g. very clay sand or silt), a very different type of impingement behaviour occurs. This is because the swirl component of the jet reaches down to the bed and so axial flow cannot escape as an under-flow, as it does with a clean sand bed. The reduction in axial velocity as the jet approaches the bed causes an increase in Swirl Number and a width-ways expansion of the jet, with an attendant adverse pressure gradient developing along the axis. The net effect is that the jet experiences a breakdown, which causes the jet to cone out as an annular jet with a central zone of re-circulating flow. The effect is described more fully by Marshall and Krishnamoorthy (Marshall, J. S. and Kiishnamoorthy, S. (1997) On the Instantaneous Cutting of a Columnar Vortex with Non-Zero Axial Flow. J Fluid Mech. Vol. 351, pp 41-74.). A suction cone (in effect, the reverse of a stagnation pressure cone formed by a turbulent round jet) develops, as indicated in FIG. 5d. Re-circulation occurs within this cone.

As shown in FIG. 5d, below a free stagnation point 30, a bubble-type breakdown develops in the form of a conical re-circulation cell defined by shear surface 31. In effect, this conical re-circulation cell is a distorted ring vortex. Consistent with the sense of rotation within the ring vortex, upward flow 32 takes place along the axis of the cell and the cell also rotates about its vertical axis due to the viscous coupling of swirl imparted from the deflected jet flow.

The size and shape of the re-circulation cell depends on (amongst other things) the Swirl Number of the primary flow, which as previously mentioned can be varied according to the pitch of the propeller. Under certain circumstances, the cell can grow until it affects the whole jet (c.f. FIG. 7b). For localised jetting (scouring) in clay, of the type described for sand, a low swirl (S=0.3) propeller would thus be used.

To increase the Swirl Number of the jet (to about S=1) and at the same time create an annular cone-shaped jet at the nozzle, a disc 18 can be placed co-axially in front of the propeller, as shown in FIG. 3. The cone angle of the resulting annular jet varies with the ratio of the diameter of the disc to the diameter of the propeller, increasing as the diameter of the disc increases. However, since the disc also causes blocking of the axial flow the maximum practical disc size is about ⅔^{rd} the diameter of the propeller (equivalent to about ¼ of the duct area). With this size of disc and a Jet Swirl Number of S=1, the jet cones out at an included angle of about 30°, as indicated in FIG. 6a.

The flow within the annular cone is essentially a spiral precessing jet flow, probably comprising four individual spiral strands reflecting the 4-bladed propeller. The central area 34 enclosed by the annular cone jet has a certain amount of swirl, but is otherwise essentially stagnant. This type of annular conical spiral jet has been described by Novalk and Sarkaya (Novak, F and Sarpkaya, T (2000) Turbulent Vortex Breakdown at High Reynolds Numbers. AIAA Journal, Vol. 38, No. 5, May 2000, pp 825-834).

The annular cone-shaped jet is particularly useful for inclined jetting, as shown in FIG. 6a, which shows a slice through the jet. It will be evident that as the angle of inclination of the jet axis with the bed decreases (from 90°), a point is reached (at about 75°) where the near side of the cone is vertical. Any greater inclination, and the whole of the annular conical jet will be deflected by the bed in the direction of inclination. By operating at an angle of inclination of about 70°, the following effects occur:

The central swirling part of the jet 34 applies suction to the bed causing a lifting of the bed material (shown by the upward arrows in FIG. 6a). This is most noticeable in clay, but it also occurs to a lesser extent in sand, where it tends to fluidise the bed material because of the upward induce flow of pore fluid.

The near-side arc of the annular conical jet 35 cuts into the bed, is deflected 36 and undercuts the lifted central area. Undercut material is pushed forward into the path of the more gently inclined far-side part of the jet 37.

Excavated material is pushed forward and sideways as the jet moves forward (see plan view in lower inset, FIG. 6b), thus removing a swathe of material equivalent to the width of the cone of impingement. Material is transported mainly as bed-load so it tends to be deposited quite close to the excavation site.

This mode of operation, although essentially a scouring method, is thus ideal for excavating a wide trench, or swathe, for the purposes of pre-trenching for pipelines.

In the case of the conical nose cone, a similar splaying of the jet occurs, initially, but further downstream the jet tends to re-form into a columnar jet. This is probably due to the fact that axial momentum is not completely blocked (as with the disc). Rather axial momentum is converted to radial (outward) momentum, which is then converted back into axial momentum as the jet re-forms. Thus there is an overall conservation of momentum (energy) within the jet.

By fitting the flared nozzle (20 in FIG. 3) the Swirl Number of the jet can be increased yet further, with a further difference in jet behaviour being obtained. Ideally, the flared nozzle would be operated in conjunction with the fore-propeller disc 18 or the conical nose cone, to raise the Swirl Number to 4 and maintain it at this level even in the free-jet condition. If the fore-propeller disc or conical nose cone are not fitted, the flared nozzle has to be operated fairly close to the bed to take advantage of the bed reaction (ground-effect) causing an increase in Swirl Number.

The flow characteristics of the free jet produced with the combination of fore-propeller disc or conical nose cone and flared nozzle, are shown in FIG. 7a. Unlike the previously described disc-induced cone-shaped jet, the flared nozzle-induced jet splays out at a wider angle (approximately 60°) on leaving the nozzle and the cross-sectional area of the jet effectively doubles, for each doubling in distance away from the nozzle. A considerable amount of re-circulation occurs within the body of the jet and with distance downstream the jet can be seen to ingest itself. In this form the free jet is very stable and will continue to grow as progressively more energy is coupled into the water. The internal structure and behaviour of this flared nozzle-induced jet has to do with:

The partitioning of flow by a conical shear surface 31, with its apex 30 (stagnation point) on the jet axis. This shear surface separates fast moving peripheral axial flow 33, from re-circulating flow field 38. In the re-circulating flow field, swirl 39 (which occurs in the same direction as the primary rotation) is confined mainly to the axial region.

The formation of a strong on-axis counter-flow 32.

Which, in turn, is a result of outward centrifuging of flow at the head of the counter-flow stream 40.

When the jet is brought within impingement distance of the bed (or, alternatively, grows to meet the bed), the situation as shown in FIG. 7b develops. An upward expanding spiralling funnel of counter-flow 32 becomes rooted to the bed, which has many features in common with a grounded tornado. The lower end of this counter-flow funnel 41 tends to precess around the main jet axis in a sweeping path. Bed material, carried aloft in this spiralling flow, is flung out sideways at higher levels due to the strong centrifuging action. Some of this material is carried back downwards in the re-circulating flow 38; the bulk of the material, however, is entrained into the peripheral deflected axial flow stream 33, to be carried away where the latter stream meets and runs out across the bed 42. Note that a distinct circular stagnation ridge 43 develops where the shear surface 31 meets the bed.

Because the deflected peripheral jet-flow effectively captures all the material excavated beneath its umbrella-shaped envelope, there is little escape of suspended sediment in the surrounding water column. This is an important feature in terms of maintaining water quality.

Depending on the frictional nature of the bed material, the re-circulating flow may either experience a decay in swirl component (in the case of sand or gravel), in which case a strong near-bed centripetal flow 44 (Eckman layer flow) develops. This inward flow tends to be very erosive, because of the high turbulence, density and viscosity of the fluid (elevated density and viscosity are due to the fine material already entrained in suspension). Although erosion tends occur over the whole footprint area, it is concentrated towards the point 41 where upward movement takes place (note that this point is constantly moving as a result of precession of the counter-flow funnel). A central erosion pit thus forms, into which gravity contributes to the centripetal transport of material.

If, on the other hand, the bed material is clay, or other low friction material (silt or very clayey sand) a strong suction develops, which either fluidises the bed material or induces it to fail in tension (spalling failure). Because most cohesive soil materials are weakest in tension, compared to compression and shear, this is a very efficient mode of excavation. Even very stiff clay materials (with a shear strength of 200 kPa), not otherwise easily excavated by low-pressure water-jetting methods, can be excavated by this means. Since lumps and granules of excavated clay will invoke a frictional response, any loose excavated material will be automatically swept inwards towards the lofting zone.

The effect of bringing the jet closer to the bed, combined with the strong centrifuging action, is to make the impinging jet umbrella-shaped, as shown in FIG. 7b, thus widening the excavation footprint.

Because of:

The relatively high concentration of material entrained into the deflected jet flow, increasing the latter's density relative to the ambient fluid.

The high velocity of the deflected jet flow stream.

The shape of the impingement cone, in effect, creating an outward sloping ramp.

The reduction in radial velocity as the deflected jet descends to the bed, reducing the interaction between the deflected jet flow and the ambient fluid.

The impingement processes, as described, create the ideal conditions for the initiation of a high-speed, high concentration, poly-dispersed, turbidity (or gravity) current.

The process of initiating a turbidity current flow when the apparatus is operated with the flared nozzle is shown diagrammatically in FIG. 9. FIG. 9A shows how material is transported in all direction with the jet orthogonal to the bed (note that for brevity the left-hand portion of FIG. 9a has been omitted). FIG. 9B shows how material is transported in a preferred direction, in the case of an inclined jet. The head of the turbidity current flow 51 is shown as a recumbent flow structure, having many similarities to a spreading ring vortex (see Appendix B). This is followed by the body of the flow 52. Note that the angle of inclination of the jet to the bed has to be less than about 65° (25° of inclination off the vertical), otherwise the whole process breaks down.

Turbidity current flows are able to transport suspended sediment over long distances, even across a flat or only gently inclined bed. This latter ability, combined with rapid and efficient excavation, therefore, makes the operation of the first embodiment apparatus, fitted with the flared nozzle, very suitable for bull( excavation and movement of bed material in navigation channels. The term ‘Sediment Management’ has been coined for this type operation, to distinguish it from dredging, where material is mechanically removed from the bed and bodily transport to a disposal site. The operation is also very different from Water Injection Dredging, as described by Estourgie (Estourgie, A. L. P.—Theory and Practice of Water Injection Dredging, Terra et Aqua, No 38, (1988), 21-28). Although the latter type of dredging also invokes a turbidity current mode of transport, it achieves this by means of jet penetration into the bed and associated fluidisation of the bed material.

In order to appreciate the significance of invoking a turbidity current mechanism of transport, a brief description of turbidity current flows is appropriate. This is given in Appendix B.

Apart from the distance of transport, the bed-hugging nature of turbidity current flows is particularly advantageous for environmental (water quality) reasons, since it minimizes the extent to which sediment particles are carried upwards in suspension into the overlying water column.

Referring to FIGS. 8a, b and c, there is illustrated the second embodiment of the swirling jet-producing apparatus of the present invention. Depending on the particular application, the size of the apparatus used may be varied, but it will always be significantly smaller than tat of the first embodiment apparatus.

The second embodiment apparatus comprises a simple barrel-shaped body 45 of mono-bloc construction, enclosing a central duct 46, which is closed at the top end. At the top blind end of the duct there is a circular recessed inner chamber 47, which has two or more pairs of holes 48 leading into. The disposition of these holes, in relation to the circular inner chamber, can be better seen in section A-A′, in FIG. 8b. The holes (of which there are four in the embodiment shown) can be seen to be in opposing pairs on two levels, with each pair being displaced by 90° in order to avoid mutual interference as the flows enter the inner chamber. A further reason for these holes being in pairs is to ensure a balance of swirling flow through the apparatus. The holes, which have rounded inlets, carry fluid under pressure into the inner chamber, where the fluid is made to rotate due to the shape of the chamber and the tangential disposition of the holes. Rotating (i.e. swirling) fluid spills out into duct 46 and is forced down the duct towards outlet 49. This downward forcing of flow, due to the volume of fluid entering through holes 48, provides the axial component of flow. Outlet 49 may have the same diameter as the duct or, as in FIG. 8a, it may be flared out. Thread 50 provides a simple means for attaching the second embodiment apparatus to the deployment means.

The size and number of holes 48 in relation to the size of duct 46, in effect, defines the swirl-to-axial velocity ratio (i.e. Swirl Number) of the flow emitted from the device. This sizing relationship would typically be chosen to give a Swirl Number of S=1 for the flow emitted from the duct. By shaping the outlet 49 in the form of a flare, a Jet Swirl Number of S=4 can be obtained, thus giving a jet with the form shown in FIGS. 7a and b. However for certain scouring-type or stand-off jetting applications, where a straight-sided jet is required, it may be more appropriate to use a non-flared duct and a lower Swirl Number (i.e. S=0.3).

It will be appreciated by those experienced in the art of underwater jetting (using pressure jets) that the energy of a normal turbulent high-pressure/high-velocity round jet dissipates very rapidly with distance from the nozzle due to entrainment of the ambient fluid and lateral expansion of the jet. In this case, however, because the apparatus is designed to emit a relatively low-pressure swirling flow, the jet maintains its integrity for longer, as outlined for the first embodiment apparatus. Nevertheless the second embodiment apparatus would normally be operated at a maximum 20-nozzle diameters from the bed. It will also be appreciated that the inlet water can only be raised to high pressure (20-150 bar), economically, in relatively small quantities. Such pressures are required to drive the flow through the apparatus.

Accordingly, the means for deployment of the second embodiment apparatus involves a multitude of small nozzles held equidistant and relatively close to (typically less than 0.5 m above) the bed. In FIGS. 10a, b and c and FIG. 11 an in-line manifold arrangement for supporting the nozzles is shown, with the nozzles disposed along the manifold at intervals such that the bed impingement footprint of each nozzle overlaps slightly with that of the adjacent nozzles. Adjacent nozzles would be configured to create contra-rotating jets. The general form of construction of the manifold (common to each of the means of deployment discussed) will now be described by reference to FIG. 10a.

In FIG. 10a, the manifold 53 is supported on wires 54 attached to the two ends of the manifold. The attachment points 55 allow adjustment of the angle of forward/backward tilt of the line of nozzles relative to the bed. Raising or lowering of either wire also allows the manifold to be tilted sideways. The manifold is intended to be supported from a vessel-mounted A-frame or crane (not shown).

The manifold 53 comprises an I-section steel beam 56 in which circular threaded holes are formed in the web, at equal intervals along its length, for insertion of the individual nozzles 45. A half section steel tube 57 is welded to the top of the I-beam, as shown, to form an enclosed channel through which the high-pressure fluid can circulated before entering the nozzles. The two ends of the channel are blanked off by means of plates 58.

The down-stands 59 on the I-beam provide protective skirts to prevent mechanical damage to the exposed part of the nozzles.

One or more inlet pipes 60 formed on the top of the manifold provide for ingress of high-pressure fluid. The latter may be generated on the vessel and conveyed to the manifold through a flexible hose or, alternatively, and as indicated in FIG. 10a, the high-pressure fluid may be generated on the manifold by means of two multi-stage electric submersible pumps 61. The arrangement shown in FIG. 10a would be used, for instance, for deeper water operation, since it is more efficient to convey electrical power to submersible pumps, than high pressure fluid, from pumps, over long distances.

The pumps 61 are placed motor-end to motor-end with a common shroud pipe 62 extending around the pump intakes 63. This is to ensure a cooling flow of water over the pump motors. A length of Johnson (or similar) well screen 64, forming part of the shroud, provides additional protection against ingress of oversize material into the pumps. For the reasons outlined for operation of the first embodiment apparatus with the flared nozzle, excavation does not throw suspended sediment into the water column so the pumps will not be exposed to excessive quantities of sediment, despite being operated close to the bed.

In FIG. 10b essentially the same manifold construction is used, but manifold 53 forms the cross member of a T-shaped pipework arrangement, which comprises a downpipe 65 and a swivel inlet pipe arrangement 66. The latter conveys the high-pressure water from the downpipe to the manifold, while allowing the manifold to be rotated about its long axis. Rotation of the manifold is achieved by means of the hydraulic ram 67, whose extension can be linked directly to the angle of the downpipe. Controlled rotation of the manifold means that the angle of the line of nozzles relative to the bed can be maintained constant regardless of the water depth.

A similar (but passive) swivel pipe arrangement 68 is used at the upper end, which allows articulation of the downpipe and connects the vessel-mounted pumps (not shown) to the downpipe. The vessel as shown, is a twin-hulled barge, with an A-frame 69 that can be used to raise and lower the manifold by means of a winch (not shown) and maintain it at the correct height off the bottom.

In FIG. 10c, a similar but smaller-scale version of the manifold is shown. In this case, manifold 53 is mounted on the backhoe arm 70 of a mechanical excavator 71 and the high-pressure fluid is supplied via a flexible hose 72 from pump 73. The tracked excavator would be operated from a barge or pontoon, or off the side of a jetty or dock, as in the case of FIG. 10c.

A similar arrangement to that shown in FIG. 10c might also be used for cleaning ships' hulls. Although in this case, the two ends of the manifold would be fitted with wheels designed to maintain the manifold and the nozzles at the optimum distance from the hull. Also, the nozzles would be operated normal to the hull surface. The optimum distance would be a balance between maximum cleaning efficiency and the suction effect induced by the jets (when operating at a jet Swirl Number of S=4) that would be used to hold the manifold firmly against the hull.

An alternative deployment arrangement for cleaning ships' hulls is shown in FIG. 11. In this arrangement, there are pairs of wheels 74a and 74b at either end of manifold 53, which are supported on struts 75 in such a way that they maintain the nozzles at a fixed distance from, and normal to, the hull. One of the wheels in each pair is a drive wheel, and in the case of the design shown in FIG. 11, an enclosed drive shaft connects this drive wheel to a hydraulic motor and gearbox 76 located at each end of the manifold. The two drive motors can be operated together or independently, so that the whole machine can be moved forwards or backwards, or steered right or left.

High-pressure fluid from a pump (not shown) is supplied to the nozzles via a flexible hose 72, loosely bundled to which are the hydraulic hoses 77 to power the drive motors. This machine is of relatively light-weight construction, being designed to adhere to the hull purely as a result of the suction created by the jets. It will be appreciated that not all of the nozzles need create suction, provided there is sufficient net suction to achieve adherence of the machine, some of the nozzles can emit low Swirl Number (S=0.3) straight-sided scouring type jets. The machine is also designed to be remotely operated from a support vessel (not shown), which provides the source of high-pressure fluid for the nozzles and also hydraulic power for the drive motors.

In FIG. 12a what is perhaps the simplest means for deploying the second embodiment apparatus is shown, in the form of a hand-held single-nozzle jetting lance. The components of the jetting lance consist of the following: a handle 78 for holding the device, an on-off trigger mechanism 79, and a means 80 for adjusting the volume of flow. High-pressure water is supplied through flexible hose 81 and is transmitted via extension pipe 82 to the jetting head 83. The lower inset sketch (FIG. 12b) shows an enlarged section through the jetting head to illustrate how the nozzle 45 is inserted. Swirling jet-emitting nozzle 45 has essentially the same construction as that shown in FIG. 8a. To protect the nozzle from mechanical damage, jetting head 83 may be extended to form shroud 84.

Since this deployment means is intended, primarily, for diver operation, it will be appreciated that further adaptation of the water delivery and control arrangement may be appropriate to suit diver-operating (ergonomic) requirements. However, the jetting head will remain as shown in FIG. 12b. One of the features of this jetting head arrangement is that the nozzles can be changed very easily, so that different Swirl Number nozzles can be used, as required.

One of the advantages of a high Swirl Number jet compared to a normal (non-swirling) axial flow jet, for hand operation, is that the swirling jet produces very little reaction when operated against a solid surface. In fact, when using the flared nozzle at optimum range there is no reaction at all, as suction balances thrust within the jet. Additional advantages in the case of the flared nozzle when used for cleaning purposes are:

The jet splays out from the nozzle at a wide angle, thus covering a larger jetting area

The outer part of the jet entrains suspended material and carries it away sideways across the jetting surface, so there is no loss of visibility.

These latter advantages can be visualised by comparing FIG. 7b (flared jet) to FIG. 5a (straight jet).

Appendix A (Note the Following Definition is Complied from Standard Texts.)

Swirl Number is a non-dimensional, device-independent measure of the ratio of axial fluxes of swirl and linear (axial) momentum in a flow, divided by a characteristic radius.

Swirl Number (S), is defined as:

$$S = \frac{1}{R} \frac{{\int }_{0}^{R} {r}^{2} UV ⅆ r}{{\int }_{0}^{R} {rU}^{2} ⅆ r}$$

Where: R=inlet radius
r=radius of measurement
U=axial velocity
V=tangential velocity (swirl)
   Appendix B

Turbidity currents are a particular class of density flows. Density flows are produced where gravity acts upon a density difference between two fluids, causing the denser fluid to move. The denser fluid travels as a relatively thin layer across the bed, in effect wedging up the less dense fluid at its leading edge. With turbidity currents, the density difference is produced by particles maintained in suspension and convected by the moving fluid. Density flows can also be produced, for example, by concentrated salt solutions, temperature differences in air or water, dense suspension of particles in air (dust or snow).

In the case of turbidity currents the particles are in a transient state of suspension and will tend to sediment out. The distance over which particles can be transported in a turbidity current thus depends on the length of time that the particles can be buoyed up in the flow. The processes involved are complex, interactive and highly non-linear, and turbidity currents are in a continual state of flux as they adjust to internal and external factors.

To initiate a turbidity current, requires a particular set of circumstances, which can best be demonstrated by a simple kitchen sink experiment. This involves dropping a dense suspension of cornflour in water into a basin containing a few centimetres of clean water. It will be seen that the cornflour spreads out as a ring (ring vortex) across the bottom of the basin. The ring, which typically has a recumbent leading edge, is the head of the turbidity current, inside of which is a much thinner dispersed layer of cornflour, which is the body of the turbidity current.

If the cornflour is poured rather than dropped, it will be seen that the same ring vortex forms and is fed by the stream through the thin body layer. A steady stream of cornflour creates what is known as, a constant-flux turbidity current.

The three basic ingredients required to initiate a turbidity current are:

1. A means for generating a free vortex, in this case by creating shear between two fluid bodies

2. Sufficient density difference between the two fluid bodies

3. Sufficient momentum in the denser fluid body

Since the body of a constant-flux turbidity current carries the bulk of the suspended material, it plays a key role in terms of sediment transport. Amongst a wide range of factors, the following can be cited as important in achieving long-distance transport:

Small particles (particularly silt and clay size particles) can be transported further because of their low settling velocity

A high concentration, particularly of fine particles, will be transported further due to hindered settling (interaction between particles) and because of increased viscosity (less drag between current and overlying ambient fluid)

A high concentration of clay particles will assist transport of coarser particles (silt and sand) because of the increased viscosity of the flow

Elevated turbulence in the flow (high Reynolds stresses) will increase the distance of transport because turbulent eddies help to buoy up the suspended particles.

Many of these factors are discussed by Kneller and Buckee (Kneller B. and Buckee C.—The Structure and Fluid Mechanics of Turbidity Currents: a review of some recent studies and their geological significance, Sedimentology, Vol 47 (Suppl. 1) (2000), 62-94).

1. A fluid jet generating apparatus comprising swirling jet flow generation means.

2. An apparatus as claimed in claim 1 comprising a duct having a fluid inlet and a fluid outlet, and a propeller mounted for co-axial rotation within the duct.

3. An apparatus as claimed in claim 2 wherein the propeller is adapted to produce a variety of swirling jet flows.

4. An apparatus as claimed in claim 2 further comprising a disc (18) mounted co-axially in front of the propeller, wherein the disc cuts-out axial flow through a central part of the propeller.

5. An apparatus as claimed in claim 2 wherein the propeller has a rounded nose cone (19).

6. An apparatus as claimed in claim 2 wherein the propeller has a conical nose cone.

7. An apparatus as claimed in claim 1 comprising fluid flow means to cause the flow of a fluid through a duct having a fluid inlet and a fluid outlet, where the duct incorporates a static swirl generator adapted to impart swirl to the fluid.

8. An apparatus as claimed in claim 2 wherein the fluid outlet of the duct further comprises a flared nozzle.

9. An apparatus as claimed in claim 1 further comprising mounting means for mounting the fluid jet apparatus, the mounting means enabling control of an angle and elevation of the jet above a surface.

10. An apparatus as claimed in claim 2 further comprising flow intake restriction means to vary the amount of inflow to the duct.

11. An apparatus as claimed in claim 10 wherein the flow intake restriction means comprises an arrangement of louver plates.

12. An apparatus as claimed in claim 1 wherein the apparatus generates a jet having a pre-determined Jet Swirl Number of from S=about 0.3 to S=about 4.

13. An apparatus as claimed in claim 7 comprising a barrel-shaped body enclosing a fluid flow duct 46 closed at a first end and open at a second end; wherein said first end includes a recessed inner chamber 47, having a plurality of inlet passages 48 leading thereinto, generally tangentially disposed with respect to inner chamber 47, formed in opposing pairs each pair being axially spaced and rotationally displaced with respect to an adjacent pair.

14. An apparatus as claimed in claim 13 comprising four inlet passages 48, arranged in two axially spaced pairs rotationally displaced by 90°.

15. An apparatus as claimed in claim 13, wherein the second, or open, end of duct 46 comprises a flared outlet.

16. An apparatus as claimed in claim 13 wherein the body is provided with a threaded portion for attachment of the apparatus to a deployment means, the deployment means comprising fluid flow means to supply a flow of a fluid to the inlet passages 48.

17. A dredging, scouring, excavating or cleaning apparatus comprising an apparatus as claimed in claim 1.
